(19) United States
(12) Patent Application Publication
(10) Pub. No.: US 2003/0097452 A1
(43) Pub. Date: May 22, 2003

(54) Home network system

(75) Inventors: Sun-Young Kim, Seoul (KR); Young-Man Kim, Seoul (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/164,622

(22) Filed: Jun. 10, 2002

(30) Foreign Application Priority Data
Nov. 16, 2001 (KR) 2001-71338

(51) Int. Cl. G06F 15/16

(52) U.S. Cl. 709/229

(57) ABSTRACT

A home network system having a set-top box for a television and a gateway which connects the set-top box with a plurality of electric home appliances and the Internet. The set-top box transmits/receives to/from a controller used by a user and has product information of the electric home appliances. The set-top box stores screen information for the television and control information for the home electric appliances, such that programs and an authentication procedure required to control the home electric appliances are not necessary. Thus, the home network system does not require an additional authentication module, reducing the producing cost of the home network system, and saving time and cost of development due to the additional authentication module.

### CROSS-REFERENCE TO RELATED APPLICATIONS

This application claims the benefit of Korean Application No. 2001-71338 filed Nov. 16, 2001, in the Korean Patent Office, the disclosure of which is incorporated herein by reference.

### BACKGROUND OF THE INVENTION

1. Field of the Invention

The present invention relates generally to home networks, and more particularly to a home network system, which does not have an additional authentication module.

2. Description of the Related Art

Generally, a home network is realized by connecting various kinds of electric home appliances installed in a home via a single network using a gateway. A television is connected to an additional set-top box to control the electric home appliances, as a method of utilizing conventional electric home appliances.

However, the conventional home network system which uses a television to control electric home appliances is problematic in that the system must have a set-top box and additional hardware and software program authentication modules so as to control the electric home appliances in a home. Further, the conventional home network system is disadvantageous in that the server must have information with which to present a control screen of each electric home appliance, because the resolutions of conventional televisions and the server for providing information are not the same.

### SUMMARY OF THE INVENTION

Accordingly, the present invention has been made keeping in mind the above problems occurring in the related art, and an object of the present invention is to provide a home network system, which does not have an additional program authentication module.

Additional objects and advantages of the invention will be set forth in part in the description which follows, and, in part, will be obvious from the description, or may be learned by practice of the invention.

In order to accomplish the above and other objects of the invention, the present invention provides a home network system, comprising a gateway connected to a plurality of electric home appliances; and a set-top box which transmits/receives to/from a controller used by a user and stores product information of the electric home appliances, the set-top box being connected to the gateway.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a conceptual diagram of a home network system according to an embodiment of the present invention; and

FIG. 2 is a detailed block diagram of the set-top box shown in FIG. 1.

### DESCRIPTION OF THE PREFERRED EMBODIMENTS

Reference will now be made in detail to the present embodiments of the present invention, examples of which are illustrated in the accompanying drawings, wherein like reference numerals refer to like elements throughout.

A home network system according to the present invention allows a user to control various electric home appliances, monitor operations of the appliances, and access the Internet, through a television. In order to perform these functions, the construction of the network is described as follows.

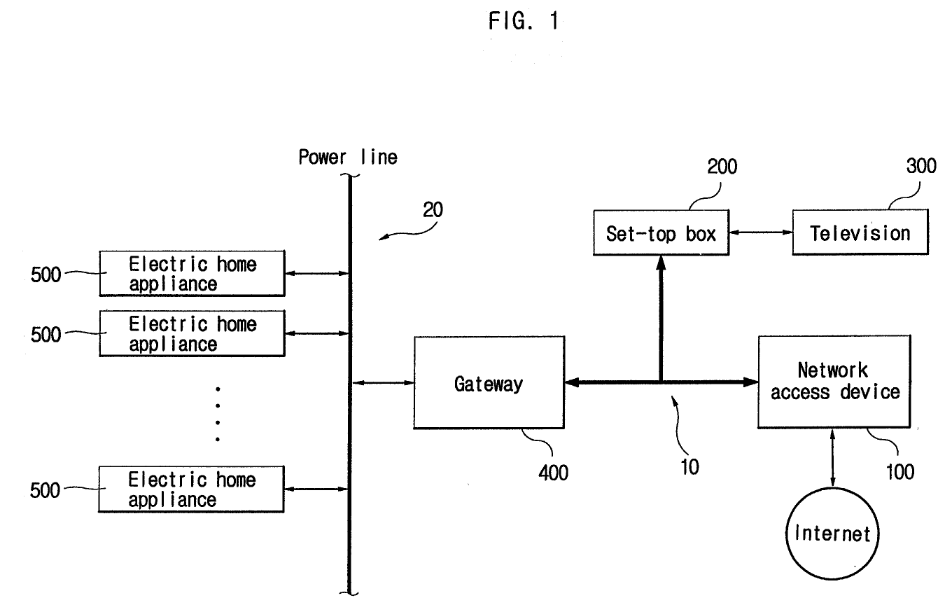

FIG. 1 is a block diagram of a home network according to an embodiment of the present invention.

Referring to FIG. 1, the home network comprises a television 300, a set-top box 200, and a gateway 400. The television 300 is the controller used by the user. The set-top box 200 transmits and receives information to/from the television 300. The gateway 400 is connected to the set-top box 200 through a LAN (Local Area Network) line 10 and connected to a plurality of electric home appliances 500 through a power line 20.

Further, the home network of this invention has a network access device 100 connected to an external network, such as for example, the Internet. The network access device 100 is connected to the set-top box 200 and the gateway 400 through the LAN line 10. The network access device 100 for accessing the Internet is an ADSL (Asymmetric Digital Subscriber Line) modem, a cable modem, a modem using a leased line, a telephone line, or other device which connects with the Internet via a communications path.

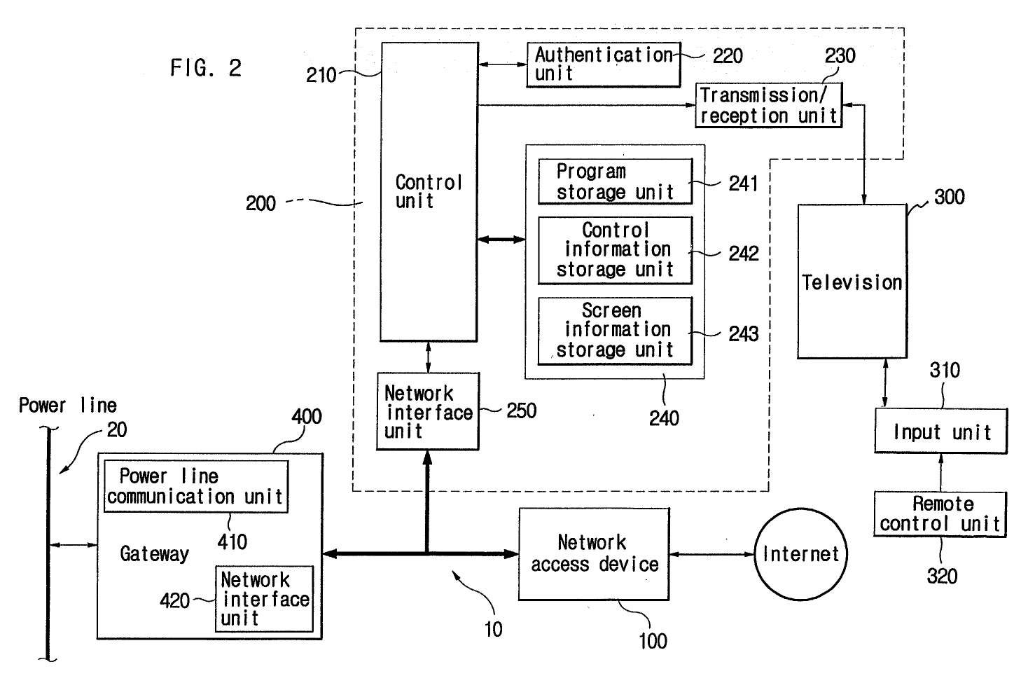

FIG. 2 is a detailed block diagram of the set-top box of the present invention.

Referring to FIG. 2, the set-top box 200 comprises a control unit 210 which controls an overall operation of the set-top box 200. The control unit 210 is connected to a network interface unit 250 which interfaces the control unit 210 with the network access device 100 and the gateway 400.

The set-top box 200 further comprises a storage device 240 which stores an operation system necessary for operation and various kinds of programs. The storage device 240 is realized as a hard disc or a flash memory, but may be realized in other types of memory as well.

The storage device 240 comprises: a program storage unit 241 which stores operating programs, an Internet browser, and related data; a control information storage unit 242 which stores control and status information of the electric home appliances 500; and a screen information storage unit 243 which stores control screen information of the plurality of electric home appliances 500 (FIG. 1). The screen information storage unit 243 stores the screen information of a user interface preset to correspond with a resolution of the television 300, and the user interface is made in a convenient language, such as for example, HTML (Hypertext Markup Language).

The set-top box 200 further comprises an authentication unit 220, in which the user authentication required to install software and other information used in the television 300 and other peripheral devices is constructed in hardware. The other peripheral devices include personal computers, Web pads, the set top box and the like which are connected via the LAN 10. Accordingly, the authentication procedure is automatically performable.

The set-top box 200 further comprises a transmission/reception unit 230 which transmits information to the television 300, or receives information from the television 300.

The gateway 400 comprises a power line communication unit 410 which connects power lines between the gateway 400 and the electric home appliances 500, and a network interface unit 420 which interfaces with both the network access device 100 and the set-top box 200 through the LAN line 10.

Hereinafter, the operation and effect of the home network described with reference to FIGS. 1 and 2 is described in detail.

In one mode of operation, a user inputs information through an input unit 310 using a remote control unit 320 to control one or more of the plurality of electric home appliances 500. Upon receipt of the user information, the television 300 requests information for the control screen of the set-top box 200. Accordingly, this request signal is transmitted to the control unit 210 through the transmission/reception unit 230 of the set-top box 200.

The control unit 210 of the set-top box 200 authenticates the television 300 of the user by the authentication unit 220 according to the request signal from the television 300. If the television 300 is authenticated, the control unit 210 reads data of the screen information from the screen information storage unit 243, and transmits screen information of the user interface corresponding to the screen information data to the television 300 through the transmission/reception unit 230.

The television 300 displays the information received from the set-top box 200 on its screen. The user recognizes the information displayed on the screen of the television 300, and inputs control information through the input unit 310. The control information inputted by the user is transmitted to the set-top box 200 by the television 300. The control unit 210 of the set-top box 200 analyzes the transmitted control information on the basis of the information stored in the control information storage unit 241, and transmits the analyzed information to the gateway 400 through the network interface unit 250.

The gateway 400 receives data outputted from the set-top box 200 through the network interface unit 420, and transmits data according to the information of the received data through the power line communication unit 410. Accordingly, a corresponding electric home appliance 500 receives data from the power line 20 through a power line modem (not shown) installed within the corresponding electric home appliance 500, and performs an operation corresponding to the received data.

In this case, the corresponding electric home appliance 500 sends information to the power line 20 about a status of the home appliance 500. The gateway 400 receives the status information, which is sent from the electric home appliance 500, from the power line 20 through the power line communication unit 410, and transmits corresponding status information to the LAN line 10 through the network interface unit 420.

The set-top box 200 receives the status information from the LAN line 10, through the network interface unit 250, and stores the received status information of the electric home appliance 500, in the control information storage unit 242. The control unit 210 transmits user interface screen information based on the data stored in the screen information storage unit 243 and data based on the status information stored in the control information storage unit 242 to the television 300 through the transmission/reception unit 230. The television 300 allows the user to recognize the status of a corresponding electric home appliance by displaying the information received from the set-top box 200 on the screen.

In another mode of operation, the user inputs an Internet accessing command through the input unit 310 and a signal corresponding to the Internet accessing command is transmitted to the set-top box 200. The control unit 210 of the set-top box 200 executes the Internet browser stored in the program storage unit 241 according to the Internet accessing command. The control unit 210 transmits the Internet browser, which is set to correspond with the resolution of the television 300 through the user. interface information stored in the screen information storage unit 243, to the television 300 through the transmission/reception unit 230. Accordingly, the Internet browser is displayed on the screen of the television 300.

The control unit 210 of the set-top box 200 transmits corresponding information to the network access device 100 through the network interface unit 250 to access the Internet and the network access device 100 routes communications between the set-top box 200 and the Internet.

As described above, the present invention provides a home network system, in which a set-top box has both screen information and control information of home electric appliances, such that where the user controls the home electric appliances, an authentication procedure is not necessary. Therefore, the home network system of the present invention is advantageous in that it does not require an additional authentication module, thus reducing the production cost of the home network system, and saving the time and cost for development due to the additional authentication module. Further, the present invention is advantageous because the set-top box transmits information in correspondence with the resolution of the television, there is no need to install an additional screen control device for televisions, thus enabling the user to save the purchase cost of the screen control device and improving the user's convenience in utilizing the home network system.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A home network system, comprising:
a gateway connected to a plurality of electric home appliances; and
a set-top box which transmits/receives to/from a controller used by a user, the set-top box connected to the gateway and having product information of the electric home appliances.

2. The home network system according to claim 1, wherein the set-top box and the gateway are connected to a network access device connected to an external network.

3. The home network system according to claim 1, wherein:
the controller is a television; and
the set-top box comprises:
a program storage unit which stores at least one operation program, an Internet browser, and data thereof,
a screen information storage unit which stores control screen information of the electric home appliances,
a control information storage unit which stores control information of the home electric appliances,
a transmission/reception unit which transmits/receives information to/from the television, and
a network interface unit which interfaces the set top box with the gateway.

4. The home network system according to claim 3, wherein the screen information storage unit stores user interface information preset to correspond with a resolution of the television.

5. The home network system according to claim 3, wherein the set-top box further comprises an authentication unit which stores authentication information of the television.

6. The home network system according to claim 1, wherein the gateway comprises:
a network interface unit which interfaces with the set-top box, and
a power line communication unit which interfaces with the electric home appliances through a power line.

7. A set-top box for a television which communicates control commands input through one of the television and the Internet to one or a plurality of home appliances, the set-top box comprising:
a controller which controls a flow of data between the television and the home appliances or between the internet and the home appliances to control and/or obtain information from the home appliances;
an authentication unit which authenticates a connection of the television and the controller in response to a user command input through the television;
a storage unit which stores programs and information from which the controller generates a control screen for the television to present status information relating to the one or the plurality of the home appliances to the user in a format corresponding to a resolution of the television; and
a network interface unit which connects the controller with the Internet.

8. A set-top box for a television which communicates control commands input through one of the television and the Internet to one or a plurality of home appliances, the set-top box comprising:
a controller which controls a flow of data between the television and the home appliances or between the internet and the home appliances to control and/or obtain information from the home appliances;
a storage unit which stores programs and information from which the controller generates a control screen for the television to present status information relating to the one or the plurality of the home appliances to the user in a format corresponding to a resolution of the television; and
a network interface unit which connects the controller with the Internet.
